(19) United States
(12) Patent Application Publication
(10) Pub. No.: US 2012/0313653 A1
(43) Pub. Date: Dec. 13, 2012

(54) SWITCH IDENTIFICATION SYSTEM FOR VEHICLE

(75) Inventors: Yi Lyang Jeong, Jeonju (KR); Seung Ho Yang, Ansan (KR)

(73) Assignees: DAESUNG ELECTRIC CO., LTD., Ansan (KR); HYUNDAI MOTOR COMPANY, Seoul (KR)

(21) Appl. No.: 13/233,528

(22) Filed: Sep. 15, 2011

(30) Foreign Application Priority Data
Jun. 10, 2011 (KR) 10-2011-0056414

(51) Int. Cl. G01R 27/08

(52) U.S. Cl. 324/705

(57) ABSTRACT

A switch identification system for a vehicle is provided, which is configured to identify each switch mounted in a slot regardless of which slot the switch is mounted in, such that a plurality of switches can be freely arranged in desired positions, thus more effectively managing the respective switches. In particular, an identification terminal mounted in the switch and connected to a corresponding terminal in the slot when the switch is inserted into the slot is provide along with a resistor connected to the identification terminal of the switch and having a different resistance value predetermined for each switch. The switches are identified by a control module which receives a signal based on the resistance value of the resistor in the switch through an input circuit connected to the corresponding terminal in the slot.

### CROSS-REFERENCE TO RELATED APPLICATION

This application claims under 35 U.S.C. §119(a) the benefit of Korean Patent Application No. 10-2011-0056414 filed Jun. 10, 2011, the entire contents of which are incorporated herein by reference.

### BACKGROUND

(a) Technical Field

The present invention relates to a switch identification system for a vehicle. More particularly, it relates to a switch identification system which can identify each switch mounted in a slot, even if the switch is mounted in any slot.

(b) Background Art

In general, a plurality of switches for operating various vehicle systems including lamps, electric and electronic components, convenience systems, safety systems, etc. are mounted in a vehicle. These switches are mounted in various positions of the vehicle and, as shown in FIG. 1, a plurality of switches 11 to 14 are generally mounted on an instrument panel on the side of a driver's seat such that the driver can conveniently select and operate the switches 11 to 14.

In particular, the plurality of switches 11 to 14 are concentrated around a cluster and, in the case of a large commercial vehicle such as a truck or bus, the number of switches mounted on the instrument panel is sometimes up to about 30 or 40 switches. Moreover, these many switches are not used in all vehicles in the same manner but selectively used according to the vehicle model, and further, each switch is mounted in a predetermined position in the vehicle.

Each switch is connected to a corresponding unit receiving its input in a predetermined position via wiring and, in this case, there is no structure for identifying each switch mounted in its position. Therefore, it is necessary to fix the mounting position of each switch (i.e., a switch bearing surface such as a slot into which the switch is inserted) to a predetermined position. As such, the mounting position of each switch is predetermined depending on its type (i.e., depending on its use and function), and the switch is mounted in the corresponding slot and connected by wiring. Then, when the corresponding switch mounted in its position is operated, the switch can be identified from the position of a signal according to the operation (i.e., from the operation position such as the position of the slot and wiring from which the signal is transmitted).

Moreover, when a switch does not need to be mounted in a specific slot according to the vehicle model and its use, as shown in FIG. 2, the position of the corresponding switch (i.e., the slot) is covered with a blank cover or plug 18, and only the switches 11 through 14 are mounted in predetermined positions.

Since the operation state of each switch can be transmitted from the predetermined position, the switches 11 through 14 cannot be mounted in any other positions but rather must be mounted in the predetermined positions, and the positions of dead switches, (i.e., switches which are not to be used), are covered by the blank cover or plug 18.

As such, if the connection between the switch and the wiring is fixed to a predetermined position, the degree of freedom in layout of the switches is limited at best, and thus thirty or forty switch positions must regularly be provided around the instrument panel. As a result, the switch bearing surfaces occupy most of the instrument panel, which reduces the degree of freedom in design, and it is thus hard to rearrange or move the positions of the switches to provide a more ergonomic design, which makes it difficult to satisfy the driver's increasing demands and complaints.

For example, it is difficult to move and rearrange the position of a specific switch from position ‘A’ to position ‘B’ in FIG. 1. Moreover, as can be seen from FIG. 2, the blank cover or plug 18 is mounted in the position of a switch, which is not being used, and the switches 11 through 14, which are actually necessary, are dispersed in various predetermined positions on the dashboard.

Among the many switches, a switch that is frequently used by the driver or a switch that is used in emergency should be mounted in a position adjacent to the driver such that the drive can easily operate the switch. However, the types of switches to be used are different from each other in various vehicle models, and thus it is difficult for the driver to selectively operate a necessary switch when the switches are mounted in fixed positions.

Furthermore, in a switch module shown in FIG. 2, a plurality of blank covers or plugs 18 are dispersed between the switches 11 through 14, which makes it difficult for the driver to quickly find and operate a necessary switch from the overall arrangement of the plurality of switches. If the driver has difficulty in operating the switches on the instrument panel, the operation of the switches may impair the driver's concentration, thus increasing the risk of a vehicle accident.

Moreover, from the point of view of vehicle manufacturers, it is necessary to identify the positions of the switches one by one and mount the switches in predetermined positions, and it is also necessary to identify the positions of several blank covers or plugs and mount the blank covers or plugs in the corresponding positions, which is disadvantageous in terms of workability and productivity.

Furthermore, when the switches are selectively mounted according to the vehicle model, several important switches are dispersed in various positions in a limited space, and the blank covers or plugs unnecessarily occupy space on the dashboard, which is disadvantageous in terms of space utilization.

If it is desired to obtain a layout in which the switches are arranged in desired positions, it is necessary to manufacture various types of switch modules (an example of the switch module is shown in FIG. 2) by considering the numbers of cases for the selective application of the switches. However, in order to manufacture and handle various types of switch modules for all vehicle models, the number of switch modules is increased greatly, and thus additional cost, time, and manpower are required thus making it difficult to manage the specifications of the respective switch modules.

One previous solution to solve this problem involves applying a transceiver and a microprocessor for LIN or CAN communication which is mounted in each switch such that the corresponding switch operates as a master or slave to communicate with a control module of the vehicle. However, the additional transceiver and microprocessor mounted in each switch and a program designed to operate the microprocessor cause a significant increase in the cost and require a number of design engineers required to design and make the vehicle.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a switch identification system for a vehicle, which is configured to identify each switch mounted in a slot using a simple circuit configuration, regardless of which slot the switch is mounted in, so that a plurality of switches can be freely arranged in desired positions, thus more effectively managing the respective switches.

In one aspect, the present invention provides a switch identification system for a vehicle, which identifies a switch inserted into a slot in a vehicle. More specifically, the switch identification system includes an identification terminal mounted in the switch and connected to a corresponding terminal in the slot when the switch is inserted into the slot; a resistor connected to the identification terminal of the switch and having a different resistance value predetermined for each switch; and a control module for identifying the type of switch by receiving a signal based on the resistance value of the resistor in the switch through an input circuit connected to the corresponding terminal in the slot.

In a illustrative embodiment, the control module may include an analog-digital (AD) converter (ADC) connected to the corresponding terminal in the slot through the input circuit and outputting an ADC value indicating each switches specific type by converting the signal based on the resistance value of the resistor in the switch. Additionally, the control module may further include a resistor connected to the input circuit of the AD converter.

In still another illustrative embodiment, the resistor in the switch may be a pull-down resistor connected to a ground, and the resistor of the control module may be a pull-up resistor of a power input circuit connected to the input circuit. The AD converter may include a plurality of input channels, each input channel being connected to each of a plurality of corresponding terminals of the slots through the input circuit in a one-to-one manner. The control module may further include a controller for determining the type each switch based on the ADC value output from the AD converter.

In a further illustrative embodiment, the controller may identify the type of switch by determining whether the ADC value is within a predetermined range for each type of switch and when the ADC value is out of the predetermined range, the controller may treat it as an error.

Other aspects and illustrative embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram showing a state in which many switches are mounted in a vehicle;

FIG. 2 is a diagram showing a layout of conventional switches;

FIG. 3 is a diagram showing a configuration of terminals mounted in a switch in a illustrative embodiment of the present invention;

FIG. 4 is a diagram showing a configuration of a switch identification system in a illustrative embodiment of the present invention;

FIG. 5; is a table showing an exemplary configuration of switches according to ADC values in a illustrative embodiment of the present invention and

FIG. 6 is a diagram showing a configuration of a switch module in a illustrative embodiment of the present invention.

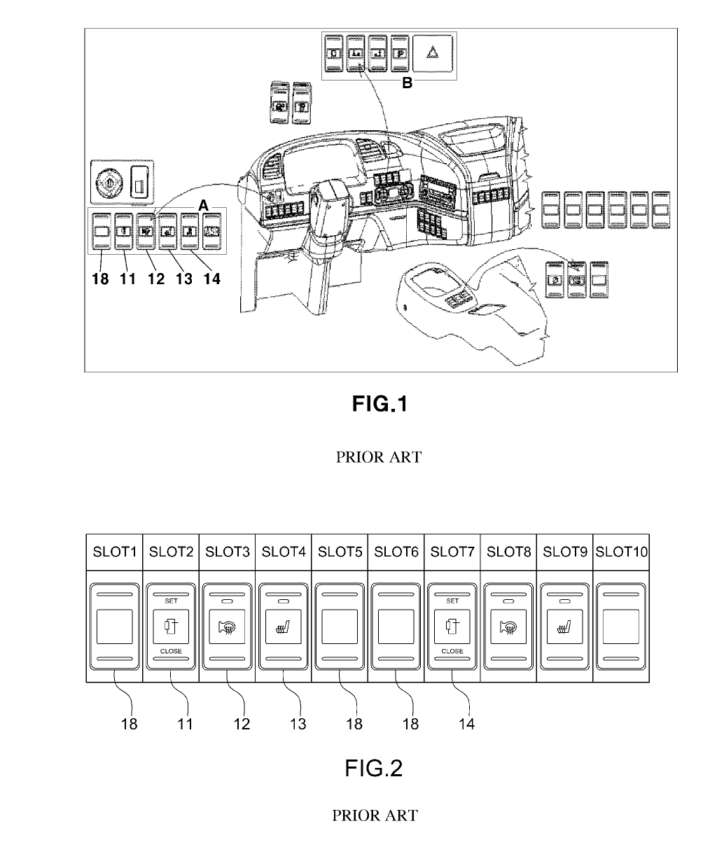

Reference numerals set forth in the Drawings includes reference to the following elements as further discussed below:
11 to 14: switches
15: identification terminal
18: blanking cover (or plug)
20: control module
21: AD converter
22: controller

It should be understood that the appended drawings are not necessarily to scale, presenting a somewhat simplified representation of various illustrative features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The present invention provides a switch identification system for a vehicle, which is configured to identify each switch mounted in a slot using a simple circuit configuration, regardless of which slot a switch is mounted in, such that a plurality of switches can be freely arranged in desired positions, thus more effectively managing the respective switches.

The switch identification system of the present invention has a simple circuit configuration which can automatically output a unique identifiable electrical signal for each switch when the switch is connected to any slot (i.e., any terminal of a vehicle).

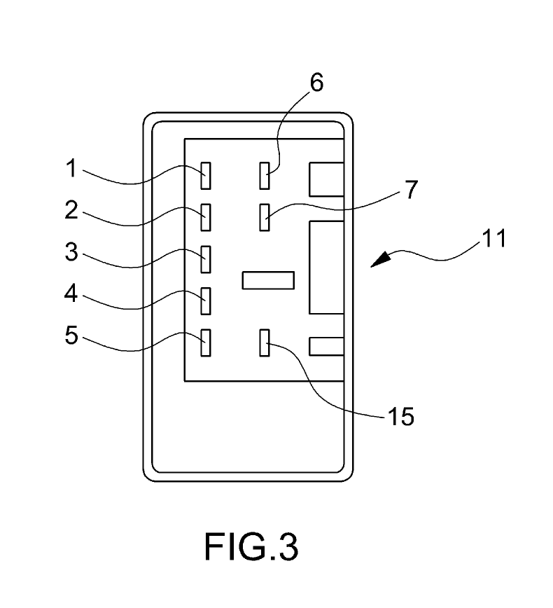

FIG. 3 is a diagram showing a configuration of terminals mounted in a switch in a illustrative embodiment of the present invention. As shown in the figure, a plurality of terminals 1 through 7 and 15 are provided at the rear of a switch 11 and, when the switch 11 is inserted into a slot formed in an instrument panel, for example, the terminals of the switch are connected to terminals in the slot of the vehicle. In the present invention, the switches have the same size and structure and thus can perform their functions, regardless of which slot they are inserted into.

As shown in the figure, the plurality of terminals 1 through 7 and 15, electrically connected to the terminals in the slot of the vehicle when the switch 11 is inserted into the to slot, are provided at the rear of the switch 11. Examples of the terminals include a switch VCC terminal 1, a ground terminal 2, a switch selection terminal 3, night lamp terminals (+/−) 4 and 5, and operation lamp terminals (+/−) 6 and 7. These terminals are used to turn on and off LEDs, which are mounted in the switch to be used as an operation lamp and a night lamp, and to output a signal according to the on/off operation of the switch. The respective terminals have the same structure and are mounted in the same positions of each switch.

Moreover, in the present invention, the switch 11 further includes an identification terminal 15, which allows a control module to intuitionally/dynamically identify the type and use of the corresponding switch upon insertion into the slot. The identification terminal 15 is also electrically connected to a corresponding terminal of the vehicle, which is further mounted in the slot.

In the present invention, the identification terminal 15 also has the same structure and is mounted in the same position as the other terminals, and the corresponding terminal (hereinafter referred to as the corresponding terminal) of the vehicle connected to the identification terminal 15 also has the same structure and is mounted in the same position. Therefore, even if any switch is inserted into the slot or even if the switch is inserted into any other slot, the identification terminal 15 of the switch 11 can be connected to the corresponding terminal of the vehicle.

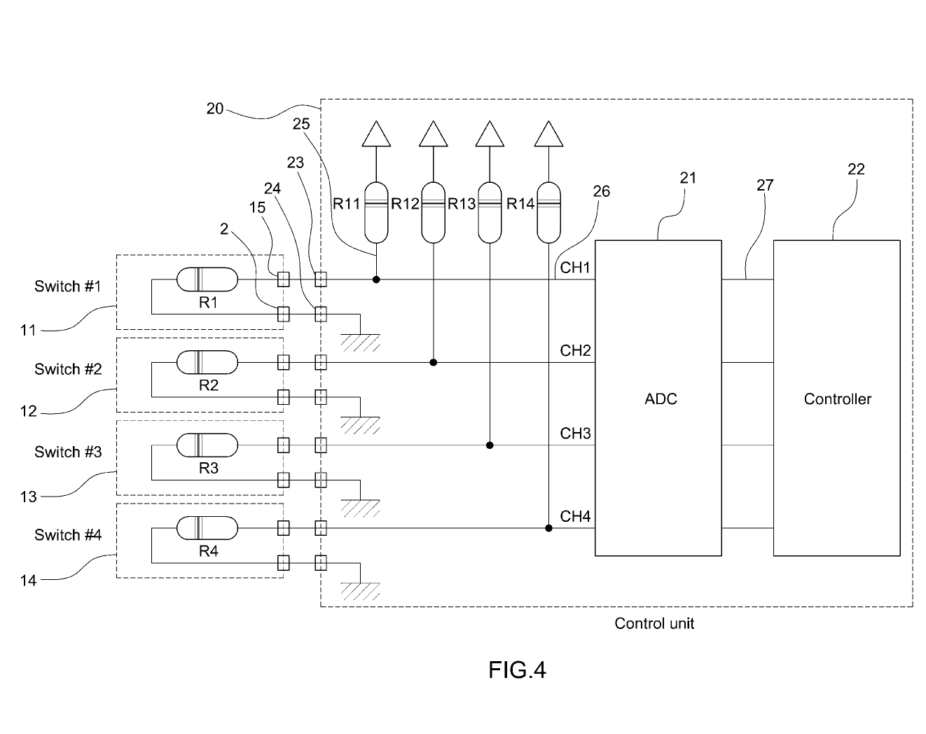

FIG. 4 is a circuit diagram showing a configuration of a switch identification system in a illustrative embodiment of the present invention, which allows a control module 20 to identify the types of switches 11 through 14 even regardless of the slot each of the switches 11 through 14 is inserted into.

As shown in the figure, when each of the switches 11 to 14 is inserted into a slot, the identification terminal 15 and the ground terminal 2 of the switch are connected to a corresponding terminal 23 and a ground terminal 24 of the slot. Each resistor R1 through R4 having a predetermined resistance value is provided in each of the switches 11 through 14, and each resistor R1 through R4 may be a pull-down resistor located between the identification terminal 15 and the ground terminal 24 and then grounded.

Each of the pull-down resistors R1 through R4 has a predetermined resistance value for each of the switches 11 through 14, and the pull-down resistors R1 through R4 of the switches 11 through 14 have different resistance values according to what type of switch it is, respectively. The pull-down resistors R1 through R4 may be mounted in the switches 11 through 14 by a method of using a printed circuit board (PCB), an insert molding method, or a method of using a variable resistor.

First, according to the method of using a PCB, a pull-down resistor having a predetermined resistance value is mounted on a printed circuit board (PCB) which is to be mounted in the switch. That is, a pull-down resistor to be applied to a corresponding switch is mounted on a PCB during a surface mount technology (SMT) process or during assembly, and then the resulting PCB is assembled to the switch during assembly of the switch so that the pull-down resistor is mounted in the switch.

In this method, various types of PCBs, on which different pull-down resistors according to the types of switches are mounted, are prepared, and a PCB including a pull-down resistor corresponding to the type of the corresponding switch is selected and used to assemble the switch. Therefore, the PCB including a pull-down resistor having a desired resistance value can be simply selected and assembled in the switch, and thus no additional processes are required.

Alternatively an insert molding method may be used, instead of mounting the resistor on the PCB. In particular, a switch body is molded using a mold, and related parts such as a PCB are assembled to provide a switch package. Then, a pull-down resistor having a predetermined resistance value according to the type of switch is attached to a predetermined position of the switch body by soldering. Here, separate terminals connected to the identification terminal and the ground terminal, respectively, are formed to extend from the switch body to the outside, and then both ends of the pull-down resistor are connected to the thus formed terminals by soldering so that the pull-down resistor can be simply connected between the identification terminal and the ground terminal.

In this method, various parts, such as the switch body, PCB, etc. are manufactured in the same manner, respectively, regardless of the types of switches being used, and assembled in advance, and then, a pull-down resistor having a desired resistance value is simply selected and assembled thereto. As can be seen, by using the above method, it is easy to mount the pull-down resistor having a desired resistance value in the switch.

Compared to the method of preparing various types of PCBs, it is not necessary to manage the specifications for the respective PCBs. Moreover, since the resistor is attached to the switch after the assembly of the switch, it is possible to manufacture the same type of switches, regardless of the vehicle models, and a suitable pull-down resistor can be selected and assembled to the corresponding switch, which is advantageous in terms of management (of the different switches) and workability such as changing the resistor values.

In some embodiments, a variable resistor may be used as a pull-down resistor that is mounted on a PCB, and then the resistance value of the variable resistor is externally set during selection of the switch. Here, the pull-down resistor may be a resistor module having a small motor, i.e., an electrical variable resistor in which the resistance value is varied using a motor. That is, after the same type switches are manufactured, the resistance value of the pull-down resistor and the type of switch can be selected by rotating the motor. After the selection of the resistance value, a lock pin may be used to fix the resistance value for that particular switch.

In this method, it is possible to increase the reliability by an automated process and perform the selection of the resistance value and the quality test at the same time. As such, the method of mounting the pull-down resistor and the method of selecting the resistance value may be performed by any one of the above three methods by comprehensively considering the manageability of the process, the convenience of management due to the common use of parts, and the cost reduction.

Meanwhile, the switch identification system of the present invention include the control module 20 for determining the type of each switch 11 through 14 inserted into each slot. The control module 20 includes an AD converter 21 electrically connected to the identification terminals 15 and the pull-down resistors R1 through R4 of the switches 11 through 15 inserted into the slots to output a unique identification signal for each switch according to the resistance value of the pull-down resistor provided in the corresponding switch.

In a illustrative embodiment, the AD converter 21 includes a plurality of input channels provided in the slots, respectively, and each input channel is connected to the corresponding terminal 23 of the slot via wiring (i.e., an input circuit 26) in a one-to-one manner. A power input circuit 25 is connected to each input circuit 26 connected between each input channel of the AD converter 21 and each corresponding terminal 23 of the slot, and each pull-up resistor R11 through R14 is mounted on each power circuit 25 connected to the input circuit 26.

Here, the pull-up resistors R11 through R14 may have the same resistance value. Therefore, when each switch 11 through 14 is inserted into any one of the multiple slots and the identification terminal 15 of the switch is connected to the corresponding terminal 23 of the slot, each pull-down resistor R1 through R4 in the switch is connected to the input channel of the AD converter 21 through the identification terminal 15 of the switch, the corresponding terminal 23 of the slot, and the input circuit 26.

Then, the AD converter 21 outputs a unique electrical signal, i.e., a unique identification signal (such as an ADC value to be described later) for each switch, which allows a user to identify the type of switch inserted into each slot. The AD converter 21 includes a plurality of output channels, each outputting a unique identification signal for each switch and connected to a controller 22 in the control module 20 via wiring, and the controller 22 determines the types of switches based on the unique identification signals output from the AD converter 21.

When a specific switch 11 through 14 is inserted into any slot, a predetermined voltage value is applied to a line connected to the switch according to a voltage division by the pull-down resistors R1 through R4 and the pull-up resistor R11 through R14 of the line connected to the input channel of the AD converter 21.

This voltage value is converted into a predetermined ADC value (analog to digital signal value), i.e., a unique identification signal for each switch by the AD converter 21, and as a result, the controller 22 in the control unit 20 receives the unique identification signal output from the AD converter 21, thereby identifying the type of switch inserted into each slot.

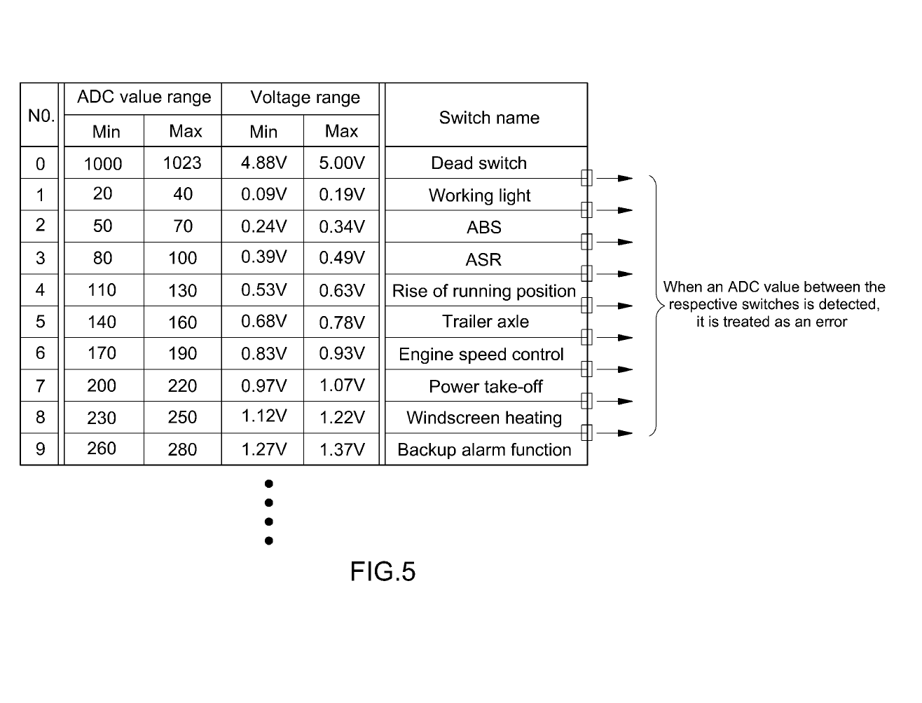

FIG. 5 is a table showing an exemplary configuration of switches according to ADC values in a illustrative embodiment of the present invention, in which the range of voltage values and the range of ADD values, which are predetermined for the types of switches, in a control module comprising an AD converter of 10 bits, are shown.

As shown in FIG. 5, since the dead slot, which is not being used, is not connected to the identification terminal of the switch having the pull-down resistor, a voltage of about 5 V (in the range of 4.88 to 5 V) is input to the input channel of the AD converter. Therefore, when the AD converter outputs an ADC value corresponding to the voltage value, the controller receives the ADV value to determine that the ADC value is within a predetermined range (1,000 to 1,023), thus identifying that the corresponding switch is not being used.

On the contrary, in the case of the slot connected to the switch, the AD converter outputs a predetermined ADC value as a unique switch identification signal based on the predetermined resistance value of the pull-down resistor for each switch, and the controller determines that the ADC value is within a predetermined range (for each type of switch), thus identifying the type of switch. When the detected ADC value is out of a predetermined range for each switch, the controller treats it as an error.

As above, the configuration of the switch identification system of the present invention has been described, in which the resistor of the switch is configured with a pull-down resistor and the resistor of the control mode is configured with a pull-up resistor of the power input circuit for the purpose of voltage division. However, the present invention may have the opposite configuration. That is, the resistor of the switch may be configured with a pull-up resistor connected to the power source and the resistor of the control mode may be configured with a pull-down resistor connected to the ground.

In the present invention, besides the above-described voltage division method based on the resistance value of the resistor mounted in the switch, it is possible to employ a method in which a signal input to an ADC channel makes a change in the ADC value by a change in current such that when the detected ADC value is within a predetermined range for each switch, the controller identifies the corresponding switch based on the detected value.

Moreover, to simplify the wiring, the control module may be divided according to the positions of the switch modules, in which a plurality of switches are grouped, respectively, and the control modules may be configured to transmit the state information of the switches between each other by various communication methods such as Local Interconnect Network (LIN) communication, Controller Area Network (CAN) communication, etc.

Furthermore, an integrated control module may be configured to receive the inputs of all switches and identify the types of switches.

As described above, according to the switch identification system for a vehicle of the present invention, the control module can identify the type of switch, regardless of which slot the switch is mounted in, and thus the switches can be freely arranged in desired positions.

Furthermore, since the control module can identify the type of switch in all cases, the switch can be simply inserted into any slot, and thus switches can be freely arranged in desired positions, thus making it possible for the user to conveniently arrange the switches in to desired positions according to the frequency of use.

As a result, the driver can customize their switches in positions which are more accessible and convenient to the driver, and thus it is possible to increase the convenience of operation, prevent a traffic accident due to careless driving, and increase the convenience of driving. Additionally, the degree of freedom in layout is improved, which is advantageous in terms of design, and it is possible to easily manage product specifications and improve the assembling workability.

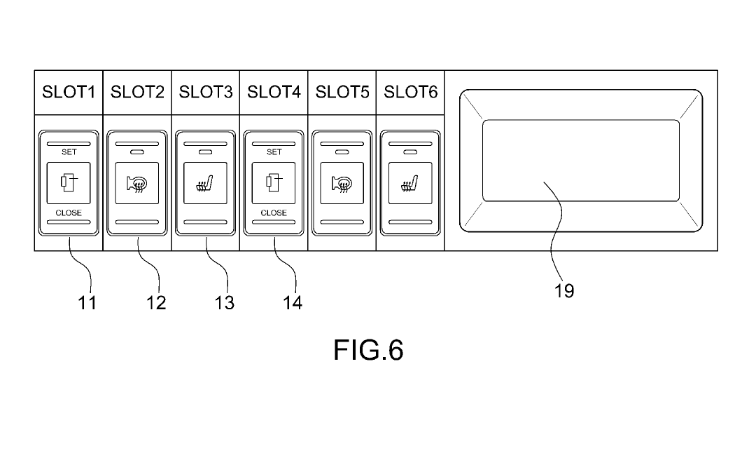

Furthermore, when the slots are provided to correspond to the number of switches to be used according to the vehicle model, the number of blank covers or plugs can be reduced or even eliminated, and the remaining space can be used as a pocket 19 as shown in FIG. 6, thus increasing the space utilization.

The invention has been described in detail with reference to illustrative embodiments thereof. However, it will be appreciated by those skilled in the art that changes may be made in these embodiments without departing from the principles and spirit of the invention, the scope of which is defined in the appended claims and their equivalents.

What is claimed is:

1. A switch identification system for a vehicle, which identifies a switch inserted into a slot in a vehicle, the system comprising:
an identification terminal mounted in the switch and connected to a corresponding terminal in the slot when the switch is inserted into the slot;
a resistor connected to the identification terminal of the switch and having a different resistance value depending on the type of switch being inserted into the slot; and
a control module for identifying the type of switch inserted into the slot by receiving a signal based on the resistance value of the resistor in the switch through an input circuit connected to the corresponding terminal in the slot.

2. The switch identification system of claim 1, wherein the control module comprises an AD converter connected to the corresponding terminal in the slot through the input circuit and outputting an ADC value indicating the type of each switch by converting the signal based on the resistance value of the resistor in the switch.

3. The switch identification system of claim 2, wherein the control module further comprises a resistor connected to the input circuit of the AD converter.

4. The switch identification system of claim 3, wherein the resistor in the switch is a pull-down resistor connected to a ground, and the resistor of the control module is a pull-up resistor of a power input circuit connected to the input circuit.

5. The switch identification system of claim 2, wherein the AD converter comprises a plurality of input channels, each input channel being connected to each of a plurality of corresponding terminals of the slots through the input circuit in a one-to-one manner.

6. The switch identification system of claim 2, wherein the control module further comprises a controller for determining the type each switch based on the ADC value output from the AD converter.

7. The switch identification system of claim 6, wherein the controller identifies the type of switch by determining whether the ADC value is within a predetermined range for each type of switch.

8. The switch identification system of claim 7, wherein when the ADC value is out of the predetermined range, the controller treats it as an error.

9. The switch identification system of claim 1, wherein the resistor is mounted on a PCB in the switch.

10. The switch identification system of claim 1, wherein the resistor is attached to a predetermined position of a switch body, which is molded using a mold, by soldering so as to be connected to the identification terminal after various parts are assembled to the switch body.

11. The switch identification system of claim 1, wherein the resistor is a variable resistor whose resistance value is varied by an external operation.

12. A method comprising:
inserting switch into slot in a vehicle configured to receive the switch, wherein the switch includes a terminal mounted in the switch and connected to a corresponding terminal in a slot in a vehicle upon inserting the switch into the slot; and
identifying, by a controller, the type of switch inserted into the slot by receiving a signal based on the resistance value of a resistor in the switch through an input circuit connected to the corresponding terminal in the slot, wherein the resistor is connected to the terminal of the switch and has a different resistance value depending on the type of switch being inserted into the slot.
